(19) United States
(12) Patent Application Publication
(10) Pub. No.: US 2024/0318366 A1
(43) Pub. Date: Sep. 26, 2024

(54) Flame Retardant Textile Product

(71) Applicant: Perrone Leather, LLC, Fultonville, NY (US)

(72) Inventor: Bartle C. Avery, Fultonville, NY (US)

(21) Appl. No.: 18/125,228

(22) Filed: Mar. 23, 2023

(51) Int. Cl. D06B 1/02; C09D 7/61; C09D 175/04; D04H 13/00; D06B 1/14

(52) U.S. Cl. CPC D06B 1/02; C09D 7/61; C09D 175/04; D04H 13/005; D06B 1/14; D10B 2331/14; D10B 2401/04; D10B 2401/20

(57) ABSTRACT

An improved fire resistant textile product that includes a substrate base layer. The substrate base layer may comprise a needle punched, nonwoven substrate formed from a synthetic material such as a polyetherimide fiber. A first coating is applied to the substrate. The first coating may comprise a mixture including: about 1-65 wt. % aluminum trihydroxide; about 1-33 wt. % polyurethane polymer; and about 1-11 wt. % H2O. An effective amount of pigment may be added to the above composition to produce a desired color. The first coating may be applied in two steps with a first rolling application followed by a spraying application to provide a coated substrate. Finally, a clear top coat may be added to the coated substrate. The finished textile product may have a maximum acceptable two minutes total heat release (HR) of 65 KW min/m2 and a peak heat release of 65 KW/m2.

### TECHNICAL FIELD

The present invention relates generally to the field of flame retardant textile products, and more particularly to a flame retardant, synthetic textile product suitable for use as interior surface coverings (vertical or overhead) or the like in aerospace and rail applications.

### BACKGROUND ART

Textile materials designed for applications such as aerospace must meet stringent guidelines with respect to flammability, weight, smoke density, smoke toxicity, thermal, and acoustical insulation.

The flammability of fabrics is determined by the nature of the fibers which make up the product. For example, some synthetic fibers such as melamine, polyaramids, acrylic and glass are inherently flame retardant, while other fibers such as cotton, polyester and linen can easily ignite. For these materials, the degree of flammability depends on the type of fiber and its characteristics. For example, a textile made from a fiber mixture usually burns faster and at higher temperatures compared to each fiber individually. Fabric flammability is also dependent on the thickness of the fabric and/or the density. Several approaches have been suggested for retarding the flammability of flammable fabrics.

One approach is to insert flame retardant agents in or on the fabric by coating of the fabric. The selection of the appropriate flame retardant agents and the appropriate method for the application on fabric largely depends on the specific textile substrate which needs to be protected. For use in textiles, a flame retardant agent preferably possesses the following properties: (a) compatible with the fabric: (b) non-harmful or beneficial to the aesthetic and textural properties of the fabric: (c) resistant to extensive washing and cleaning: (d) ecologically and physiologically safe: (e) low or zero emission of toxic gases; and, (f) relatively inexpensive. Extremely important is that the final product can withstand the required fire tests with respect to thermal insulation, smoke toxicity, and smoke density.

What is needed is an improved flame retardant synthetic textile product and a method of making the same that meets the above requirements.

### BRIEF SUMMARY OF THE INVENTION

The present invention meets the above described need by providing a fire resistant synthetic textile product that complies with smoke density, smoke toxicity, thermal, and acoustical insulation properties.

The synthetic textile product may include a substrate base layer. The substrate base layer may comprise a nonwoven substrate formed from a synthetic material such as a polyetherimide fiber. The substrate may be needle punched.

A first coating is applied to the substrate. The first coating may comprise a mixture including: about 1-65 wt. % aluminum trihydroxide; about 1-33 wt. % polyurethane polymer; and about 1-11 wt. % H2O. An effective amount of pigment may be added to the above composition to produce a desired color.

The first coating may be applied in two steps with a first rolling application followed by a spraying application to provide a coated substrate. Finally, a clear top coat may be added to the coated substrate.

The finished textile product may have a maximum acceptable two minutes total heat release (HR) of 65 KW min/m2 and a peak heat release of 65 KW/m2.

In another aspect the polyurethane polymer may be an aliphatic polyester polyurethane dispersion.

In another aspect the amount of pigment comprises about 1 to 20 wt. % of the final first coating mixture.

Another aspect provides a clear top coat that may comprise: about 1-11 wt. % H2O; about 1 to 23 wt. % polyurethane duller: about 1 to 11 wt. % polyurethane polymer: about 1 to 50 wt. % SS-1347; and about 1 to 5 wt. % silicone feel modifier.

In yet another aspect, the polyurethane polymer in the top coat may include an aliphatic polyester polyurethane dispersion.

The present invention also provides a method for producing a fire resistant textile product that complies with smoke density, smoke toxicity, thermal, and acoustic insulation properties. A substrate base layer is provided. The substrate base layer may comprise a nonwoven, needle punched, polyetherimide fiber.

A first coating may be provided. The coating may include about 1-65 wt. % aluminum trihydroxide: about 1-33 wt. % polyurethane polymer; and about 1-11 wt. % H2o. An effective amount of pigment to produce a desired color may be added to the above mixture.

The first coating ingredients may be mixed into solution to form a first coating mixture. The first coating mixture may be applied to the substrate in two stages to form a coated substrate.

In another aspect, a clear top coat may be applied on top of the coated substrate to form a fire resistant textile product.

The fire resistant textile product may have a maximum acceptable two minutes total heat release (HR) of 65 KW min/m2 and a peak heat release of 65 KW/m2.

In another aspect, the top coat comprises: about 1-11 wt. % H2O: about 1 to 23 wt. % polyurethane duller: about 1 to 11 wt. % polyurethane polymer; about 1 to 50 wt. % SS-1347; and about 1 to 5 wt. % silicone feel modifier.

In another aspect, the first coating is applied in two steps including a roller coating and a spray coating.

In yet another aspect, the method may further comprise the step of embossing the fire resistant textile product with a leather-like surface texture.

### DESCRIPTION OF THE PREFERRED EMBODIMENTS

A fire resistant synthetic textile product according to the invention complies with smoke density, smoke toxicity, thermal, and acoustical insulation properties required for use in aerospace applications and to meet requirements for rail applications.

The synthetic textile product may include a substrate base layer. The substrate base layer may comprise a nonwoven substrate formed from a synthetic material such as a polyetherimide fiber. The substrate may be needle punched. A preferred material is KUSHNBLOK® brand composite cushioning felt available from National Nonwovens located in Easthampton, Massachusetts. The composite cushioning felt is formed from a chemically enhanced needle punched, nonwoven material. The nonwoven material comprises ULTEM® brand polyetherimide fiber. The cushioning felt may be used as a thermal acoustic backing for a synthetic leather. The material absorbs sound, supports the addition of an embossed layer, and provides a flame retardant barrier to meet OSU 65/65. The material may be provided at a weight of 8.8 oz./yd, and 0.07 inch thickness.

A first coating is applied to the substrate. The first coating may comprise: about 1-65 wt. % aluminum trihydroxide (“ATH”); about 1-33 wt. % polyurethane polymer; and about 1-11 wt. % H2O. An effective amount of pigment may be added to produce a desired color. The first three ingredients ATH, polyurethane polymer, and H₂O may be mixed into solution to form the base resin. The pigment may be added at about 20% based on weight to the base resin to achieve a desired color.

The polyurethane polymer may comprise a medium hard, NMP free, high performance aliphatic polyester polyurethane dispersion. A preferred polyurethane dispersion is available under product code NE-721FD from Quaker Color in Quakertown, Pennsylvania.

The first coating composition is preferably applied by a roll coating. The first coating composition is mixed into solution, and the viscosity of the mixture is preferably about 43.0% at a temperature of 21.1 C as measured on a digital viscometer. The roll coat wet add-on is preferably 13-15 grams per 6 inch by 6 inch area. Next, the coated material is dried.

A second coat of the same mixture disclosed above may be applied on top of the first coat after it is dried. The second coat is preferably applied by spraying.

The viscosity of the above mixture is modified to be suitable for spraying by adding H₂O as will be evident to persons of ordinary skill in the art based on this disclosure. The add-on for the wet spray coat is approximately 3-3.5 g per 6 inch by 6 inch piece area.

After the second coat is applied, the coated substrate may be dried to 15 to 20% moisture content.

Next, the material may be processed through an embossing roller press.

Finally, a clear top coat may be added on top of the coated substrate. The clear top coat mixture may comprise about 1-11 wt. % H2O; about 1 to 23 wt. % polyurethane duller; about 1 to 11 wt. % polyurethane polymer; about 1 to 50 wt. % SS-1347; and about 1 to 5 wt. % silicone feel modifier.

The polyurethane duller is available under product code DT-1308 from Quaker Color in Quakertown, Pennsylvania. DT-1308 is a high efficiency polyurethane duller suitable for use in water based automotive leather topcoat formulations to reduce gloss and enhance abrasion resistance.

The polyurethane polymer may comprise a medium hard, NMP free, high performance aliphatic polyester polyurethane dispersion. The polyurethane dispersion may be obtained under product code NE-721FD from Quaker Color in Quakertown, Pennsylvania.

The silicone feel modifier is a high molecular weight water based silicone feel modifier for leather like materials. The feel modifier is used in leather topcoats to enhance surface feel properties and to improve abrasion resistance properties. The silicone feel modifier may be obtained under product code AW-858 from Quaker Color in Quakertown, Pennsylvania.

SS-137 is a finishing top coat product for upholstery leathers that is available from Quaker Color in Quakertown, Pennsylvania.

The finished synthetic textile product has a maximum acceptable two minutes total heat release (HR) of 65 KW min/m2 and a peak heat release of 65 KW/m2.

The polyurethane polymer may be an aliphatic polyester polyurethane dispersion.

An example of the present invention is summarized in Table 1.

TABLE 1

| Composition | Weight (lbs.) |
|---|---|
| Water | 2 |
| ATH | 10 |
| Quaker Urethane | 6 |
| NE 721FD | |

The above components are blended together to form a base resin. Up to 20% by weight of pigment may be added to the base resin to achieve the desired color.

A first coat may be applied to the substrate via a roll coater in a reverse application mode. The nonwoven material for the substrate comprises ULTEM® brand polyetherimide fiber. This cushioning felt may be used as a thermal acoustic backing for a synthetic leather. The material absorbs sound, supports the addition of an embossed layer, and provides a flame retardant barrier to meet OSU 65/65. The material may be provided at a weight of 8.8 oz./yd, and 0.07 inch thickness.

The viscosity for the above coating mixture as checked on NDJ-5S digital viscometer, rotor #3, rpm 12, temperature 21.1 C may be 43%. The roll coater settings may be as follows: Dwell: 9.5, Roll Gap: 10, Roll Number: 9NPL, and Roll Speed: 60. The blade pressure may be set as required by the operator to achieve the proper add on. The roll coat wet add on may be approximately 13-15 g on a 6 inch×6 inch area. The first coat is then dried on the substrate.

A second coat may be applied via an air assist spray system. The first coating mixture with pigment added may have the viscosity adjusted for spraying by adding water. For spraying Viscosity: Ford #6 cup for 40-45 sec, Pump pressure: 600 lbs.: Rotor speed 10: Spray gun-needle/nozzle-A817, Cap B20A, atomizing air 25-30 psi. The spray coat wet add on may be in the range of 3-3.5 grams on a 6 inch×6 inch area.

The material is then dried to 15-20% moisture content.

Next, the textile product may be fed through a roller press for embossing. The moisture content for embossing should be approximately 15-20%. The roller press settings may be: Pressure: 150 kg/cm, felt dwell 2.0 M/min; belt dwell 1.8 M/min, temperature 100 C.

A clear protective top coating may be applied to the fire resistant textile product as will be evident to those of ordinary skill in the art based on this disclosure.

The present invention contemplates that many changes and modifications may be made. Therefore, while the presently-preferred form of the flame retardant textile product has been shown and described, and several modifications and alternatives discussed, persons skilled in this art will readily appreciate that various additional changes and modifications may be made without departing from the spirit of the invention, as defined and differentiated by the following claims.

1. A fire resistant textile product that complies with smoke density, smoke toxicity, thermal, and acoustical insulation properties, the textile comprising:
a substrate;
a first coating applied to the substrate,
the first coating comprises:
about 1-55 wt. % aluminum trihydroxide;
about 1-33 wt. % polyurethane polymer; and,
about 1-11 wt. % H₂O,
wherein the textile has a maximum acceptable two minutes total heat release (HR) of 65 KW min/m² and a peak heat release of 65 KW/m².

2. The textile product of claim 1, wherein the polyurethane polymer is an aliphatic polyester polyurethane dispersion.

3. The textile product of claim 1, wherein the pigment is added to the other ingredients at about 1 to 20 wt. %.

4. The textile product of claim 1, wherein the substrate is nonwoven.

5. The textile product of claim 1, wherein the substrate is needle punched.

6. The textile produce of claim 1, wherein the substrate comprises a polyetherimide fiber.

7. The textile product of claim 1, further comprising an effective amount of pigment to produce a desired color.

8. The textile of claim 1, further comprising a top coat layer including:
about 1-11 wt. % H₂O;
about 1 to 23 wt. % polyurethane duller;
about 1 to 11 wt. % polyurethane polymer;
about 1 to 50 wt. % SS-1347; and
about 1 to 5 wt. % silicone feel modifier.

9. The textile of claim 8, wherein the polyurethane polymer in the top coat is an aliphatic polyester polyurethane dispersion.

10. A method for producing a fire resistant textile product that complies with smoke density, smoke toxicity, thermal, and acoustic insulation properties, the method comprising:
providing a substrate;
providing a first coating that comprises:
about 1-55 wt. % aluminum trihydroxide;
about 1-33 wt. % polyurethane polymer; and,
about 1-11 wt. % H₂O;
mixing the first coating into solution to form a first coating mixture;
applying the first coating mixture to the substrate to form a fire resistant textile product; and,
wherein the fire resistant textile product has a maximum acceptable two minutes total heat release (HR) of 65 KW min/m² and a peak heat release of 65 KW/m².

11. The method of claim 10, further comprising adding an effective amount of pigment to produce a desired color to the first coating.

12. The method of claim 10 further comprising applying a top coat.

13. The method of claim 12, wherein the top coat comprises:
about 1-11 wt. % H₂O;
about 1 to 23 wt. % polyurethane duller;
about 1 to 11 wt. % polyurethane polymer;
about 1 to 50 wt. % SS-1347; and
about 1 to 5 wt. % silicone feel modifier.

14. The method of claim 10, wherein the first coating is applied in two steps including a spray coating and a roller coating.

15. The method of claim 10, further comprising the step of embossing the fire resistant textile with a leather-like surface texture.

16. A fire resistant textile product that complies with smoke density, smoke toxicity, thermal, and acoustical insulation properties, the textile comprising:
a substrate formed from a nonwoven, needle punched polyetherimide fiber;
a first coating applied to the substrate,
the first coating comprises:
about 1-55 wt. % aluminum trihydroxide;
about 1-33 wt. % polyurethane polymer; and,
about 1-11 wt. % H₂O,
wherein the textile has a maximum acceptable two minutes total heat release (HR) of 65 KW min/m² and a peak heat release of 65 KW/m².
